(19) United States
(12) Patent Application Publication
(10) Pub. No.: US 2021/0067288 A1
(43) Pub. Date: Mar. 4, 2021

(54) USER EQUIPMENT AND WIRELESS COMMUNICATION METHOD

(71) Applicant: NTT DOCOMO, INC., Tokyo (JP)

(72) Inventors: Yuichi Kakishima, Tokyo (JP); Chongning Na, Tokyo (JP); Min Liu, Tokyo (JP); Satoshi Nagata, Tokyo (JP)

(73) Assignee: NTT DOCOMO, INC., Tokyo (JP)

(21) Appl. No.: 16/961,071

(22) PCT Filed: Jan. 14, 2019
(86) PCT No.: PCT/US2019/013497

§ 371 Date: Jul. 9, 2020

Related U.S. Application Data
(60) Provisional application No. 62/616,842, filed on Jan. 12, 2018.

(51) Int. Cl. H04L 5/00; H04B 7/06

(52) U.S. Cl. CPC H04L 5/0048; H04B 7/0626; H04L 5/0057; H04L 5/0094

(57) ABSTRACT

A user equipment (UE) is disclosed including a receiver that receives resource set information that indicates the number of selectable Channel State Information Reference Signal (CSI-RS) resources between a first CSI-RS group and a second CSI-RS group, CSI-RSs using first CSI-RS resources in the first CSI-RS group, and CSI-RSs using second CSI-RS resources in the second CSI-RS group. The UE includes a processor that selects at least a CSI-RS resource from the first CSI-RS resources and the second CSI-RS resources based on the resource set information. The UE includes a transmitter that performs CSI reporting that indicates the selected CSI-RS resource.

### TECHNICAL FIELD

One or more embodiments disclosed herein relate to a user equipment and a wireless communication method of beam management and Channel State Information (CSI) acquisition in a wireless communication system.

### BACKGROUND

In a New Radio (NR; fifth generation (5G) radio access technology) system using higher frequency, beamforming technology becomes crucial in order to achieve sufficient coverage and data rate. A beam management scheme has been newly introduced in 3GPP on top of the existing mechanism of CSI acquisition in order to efficiently control preceding operations. For a massive array system using narrow beams, it is efficient to perform link adaption with multiple steps. For example, by performing the multiple steps in beam management and CSI acquisition, a Transmission and Reception Point (TRP) can determine resources for downlink data transmission, which includes a precoder, frequency resources, User Equipment (UE) pairs for Multi User (MU)-Multi Input Multi Output (MIMO), and an Modulation and Coding Scheme (MCS).

In the Release 15 for NR (Rel. 15 NR), the beam management mechanism has been introduced targeting for a single-TRP/panel operation in which, a UE receives CSI-Reference Signals (RSs) using resources #1-#4 from a single TRP (or panel) as shown in FIG. 1. That is, the conventional 3GPP standards do not support cooperation transmission such as dynamic point selection (DPS)/dynamic point blanking (DPB), Non-coherent joint transmission (NC-JT), and coherent joint transmission (C-JT) using multiple TRPs/panels.

### CITATION LIST

### Non-Patent Reference

[Non-Patent Reference 1] 3GPP, TS 38.211 V 15.0.0

[Non-Patent Reference 2] 3GPP, TS 38.214 V15.0.0

### SUMMARY

Embodiments of the present invention relate to a user equipment (UE) including a receiver that receives resource set information that indicates the number of selectable Channel State Information Reference Signal (CSI-RS) resources between a first CSI-RS group and a second CSI-RS group, CSI-RSs using first CSI-RS resources in the first CSI-RS group, and CSI-RSs using second CSI-RS resources in the second CSI-RS group. The UE includes a processor that selects at least a CSI-RS resource from the first CSI-RS resources and the second CSI-RS resources based on the resource set information. The UE includes a transmitter that performs CSI reporting that indicates the selected CSI-RS resource.

Embodiments of the present invention relate to a wireless communication method including transmitting, from a base station (BS) to a user equipment (UE), resource set information that indicates the number of selectable Channel State Information Reference Signal (CSI-RS) resources between a first CSI-RS group and a second CSI-RS group, CSI-RSs using first CSI-RS resources in the first CSI-RS group, and CSI-RSs using second CSI-RS resources in the second CSI-RS group. The wireless communication method further includes selecting, with the UE, at least a CSI-RS resource from the first CSI-RS resources and the second CSI-RS resources based on the resource set information, and performing, with the UE, CSI reporting that indicates the selected CShRS resource.

Embodiments of the present invention can provide a beam management method applied to cooperation transmission schemes where multiple TRPs or panels are associated with CSI-RS groups

Other embodiments and advantages of the present invention will be recognized from the description and figures.

### BRIEF DESCRIPTION OF THE DRAWINGS

FIG. 1 is a diagram showing a single-TRP/panel operation in a wireless communication system.

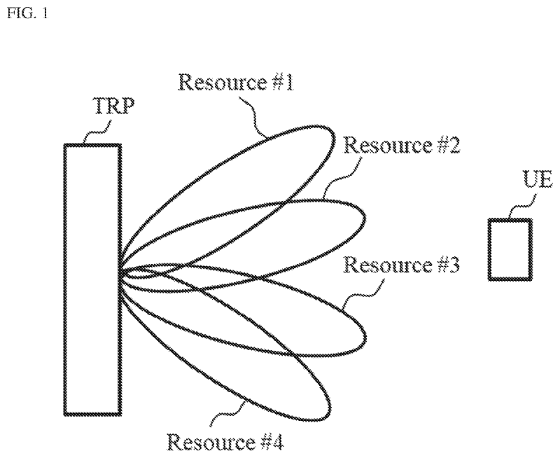

FIG. 2A is a diagram showing an example of a configuration of a wireless communication system supporting multi-TRP operations according to embodiments of the present invention.

FIG. 2B is a diagram showing an example of a configuration of a wireless communication system supporting multi-panel operations according to embodiments of the present invention.

FIG. 3 is a sequence diagram showing an example of beam management and CSI acquisition operations according to embodiments of the present invention.

FIG. 4 is a sequence diagram showing an example of beam management and CSI acquisition operations according to another example of embodiments of the present invention

FIG. 5 is a diagram showing a table where CRIs are assigned to CSI-RS resources over CSI-RS groups according to embodiments of the present invention.

FIG. 6 is a diagram showing an example of CRIs associated with CSI-RS resources included in CSI-RS reporting according to embodiments of the present invention.

FIG. 7 is a diagram showing an example of Group indexes associated with CSI-RS groups included in CSI-RS reporting according to embodiments of the present invention.

FIG. 8 is a diagram showing an example of differential feedback of RSRP in each CSI-RS group according to embodiments of the present invention.

FIG. 9 is a diagram showing an example of a configuration of a wireless communication system according to embodiments of another example of the present invention.

FIGS. 10A-10C are diagrams to explain beam failure recovery operations according to embodiments of another example of the present invention.

FIG. 11 is a diagram showing a schematic configuration of a TRP according to embodiments of the present invention.

FIG. 12 is a diagram showing a schematic configuration of a UE according to embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In accordance with embodiments of the present invention, a wireless communication system supports multi-TRP operations and multi-panel operations in beam management and CSI acquisition schemes. The wireless communication system according to embodiments of the present invention supports cooperation transmission such as DPS/DPB, NC-JT, and C-JT using multiple TRPs/panels.

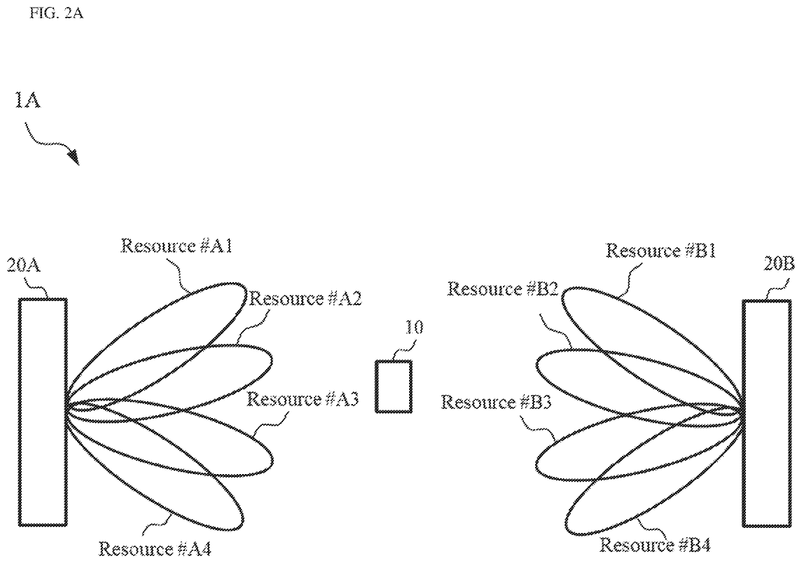

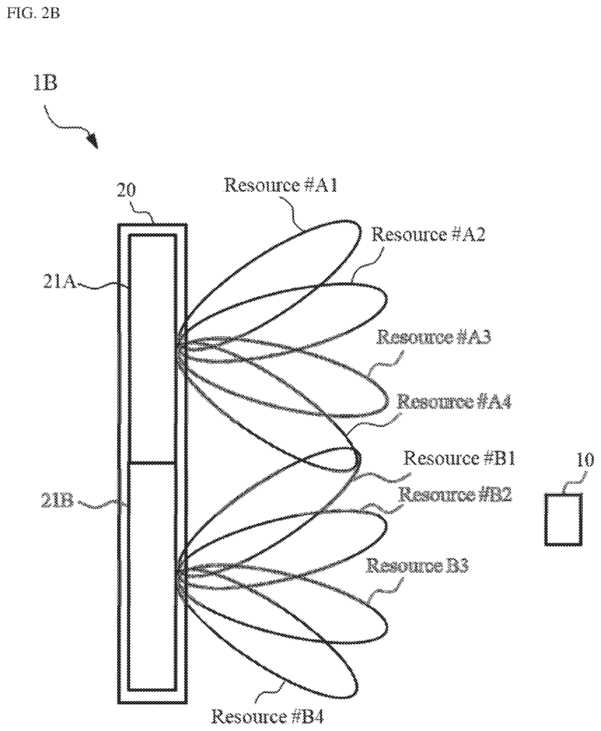

As shown in FIG. 2A, a wireless communication system 1A supporting the multi-TRP operations includes a UE 10 and multiple TRPs 20 such as TRPs 20A and 20B. The wireless communication system 1A may be a NR system. The wireless communication system 1A is not limited to the specific configurations described herein and may be any type of wireless communication system such as a Long Term Evolution (LTE)/LTE-Advanced (LTE-A) system.

The TRP 20 may communicate uplink (UL) and downlink (DL) signals with the UE 10. The DL and UL signals may include control information and user data. The TRP 20 may communicate DL and UL signals with the core network through backhaul links. The TRP 20 may be an example of a base station (BS). The TRP 20 may be referred to as a gNodeB (gNB). For example, when the wireless communications system 1A is a LTE system, the TRP may be an evolved NodeB (eNB).

The TRP 20A transmits multiple CSI-RSs using CSI-RS resources such as resources #A1, #A2, #A3, and #A4. The TRP 20B transmits multiple CSI-RSs using CSI-RS resources such as resources πB1, #B2, #B3, and #B4. The CS1-RSs transmission may be referred to as beams. A CSI-RS group is a set of resources. For example, in FIG. 2A, CSI-RS groups #A and #B are sets of resources #A1-#A4 and #B1-#B4, respectively. The CSI-RS group may be CSI-RS resource set defined in the NR specification.

In an example of FIG. 2A, each of the TRPs 20A and 20B uses four resources, but the number of resources is not limited thereto. The number of resources for each TRP 20 may be at least one.

The TRP 20 includes antennas, a communication interface to communicate with an adjacent TRP 20 (for example, X2 interface), a communication interface to communicate with the core network (for example, S1 interface), and a CPU (Central Processing Unit) such as a processor or a circuit to process transmitted and received signals with the TIE 10. Operations of the TRP 20 may be implemented by the processor processing or executing data and programs stored in a memory. However, the TRP 20 is not limited to the hardware configuration set forth above and may be realized by other appropriate hardware configurations as understood by those of ordinary skill in the art. Numerous TRPs 20 may be disposed so as to cover a broader service area of the wireless communication system 1A.

The wireless communication system 1A includes two TRPS 20A and 20B; however, the number of TRPs 20 is not limited to two. The wireless communication system IA may include two or more TRPs 20.

The LE 10 may communicate DL and UL signals that include control information and user data with the TRP 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1A may include one or more UEs 10.

The UE 10 includes a CPU such as a processor, a RAM (Random Access Memory), a flash memory, and a radio communication device to transmit/receive radio signals to/from the TRP 20 and the UE 10. For example, operations of the tiE 10 described below may be implemented by the CPU processing or executing data and programs stored in a memory. However, the UE 10 is not limited to the hardware configuration set forth above and may be configured with, e.g., a circuit to achieve the processing described below.

In embodiments of the present invention, the UE 10 may select at least a resource from the resources #A1-#A4 in the CSI-RS group #A and the resource #B1-#B4 in the CSI-RS group #B. Then, the UE 10 may perform CSI reporting indicating the selected resource.

According to embodiments of the present invention, as shown in FIG. 2B, a wireless communication system 113 may support multi-panel operations in the beam management and CSI acquisition schemes. The wireless communication system 1B includes a TRP 20 and a LIE 10/ The TRP 20 includes multiple panels 21 such as panels 21A and 21B. CSI-RSs are transmitted from each of the panels 21A and 21B using resources #A1-#A4 and #B1-#B4, respectively. A CSI-RS group #A is a set of resources #A1-#A4 used for the CSI-RSs transmission from the panel 21A. A CSI-RS group #B is a set of resources #B1-#B4 used for the CSI-RSs transmission from the panel 21B.

A wireless communication system according to embodiments of the present invention may the wireless communication system 1A of FIG. 2A, the wireless communication system 1B of FIG. 2B, or a system where the wireless communication systems 1A and 1B are combined. For example, the TRP 20A of FIG. 2A includes multiple panels that transmits CSI-RSs as multiple CSI-RS groups. For example, the wireless communication system TB may include one or more TRPs 20 in addition to the TRP 20.

Embodiments of the present invention will be described blow using an example of a system configuration of FIG. 2A for a concise explanation.

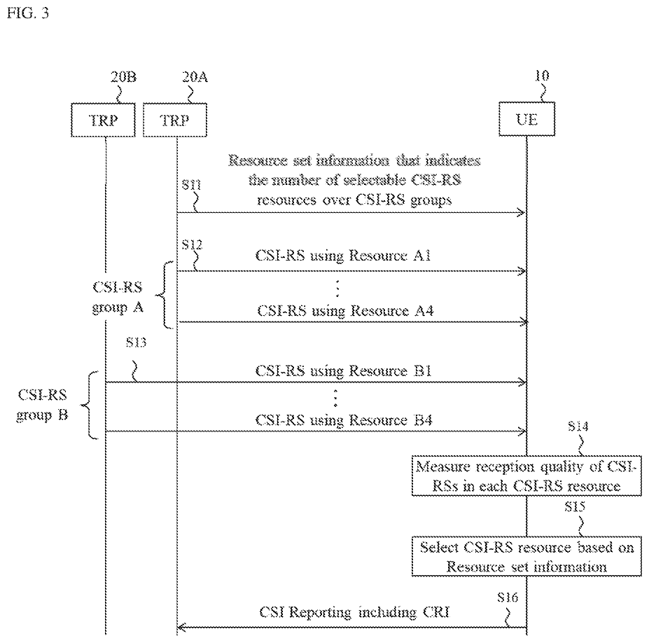

FIG. 3 is a sequence diagram showing beam management and CSI acquisition operations according to embodiments of the present invention. The wireless communication system 1A includes the LIE 10 that receives the CSI-RSs from the TRPs 20A and 20B. The TRPs 20A and 20B transmit the CSI-RSs using the resources #A1-#A4 and #B1-#B4, respectively, as shown in FIG. 2A.

At step S11, the TRP 20A transmits resource set information to the UE 10. The resource set information indicates the number of CSI-RS resources selectable in the LIE 10 over the CSI-RS groups. For example, the resource set information includes the number of CSI-RS resources selectable over the CSI groups #A and #B. For example, the number of CSI-RS resources may be a predetermined value that is less than or equal to the total number of CSI-RS resources included in the CSI-RS groups #A and #B.

For example, when dynamic switching such as the DPS/DPB is applied as cooperation transmission, the number of selectable CSI-RS resources may be one. For example, when joint transmission such as the NC-JP and C-JT is applied as cooperation transmission, the number of selectable CSI-RS resources may be two or more. For example, the number of selectable CSI-RS resources over the CSI-RS groups may be a fixed value. For example, the resource set information may indicate at least one of a maximum value and a minimum value of the number of selectable CSI-RS resources over the CSI-RS groups.

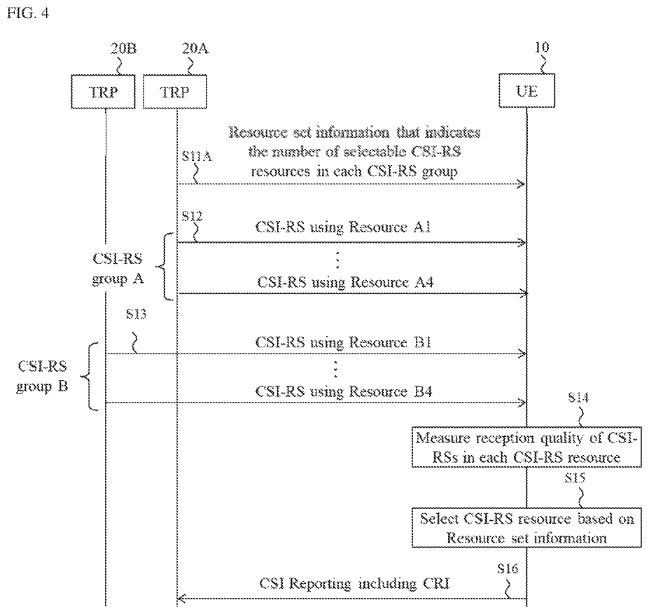

As another example, the resource set information indicates the number of CSI-RS resources selectable in the LIE 10 in each of the CSI-RS groups as shown in step ST IA of FIG. 4. For example, the number of selectable CSI-RS resources in each of the CSI-RS groups may be a fixed value. For example, the resource set information may indicate at least one of a maximum value and a minimum value of the number of selectable CSI-RS resources in each of the CSI-RS groups. For example, the maximum value of the number of selectable CSI-RS resources in each CSI-RS group may be one. Steps S12-S16 of FIG. 4 are similar to steps S12-S16 of FIG. 3.

In examples of FIGS. 3 and 4, the TRP 20A transmits the resource set information, but embodiments of the present invention are not limited thereto. For example, the TRP 20B may transmit the resource set information. For example, both of the TRPs 20A and 20B may transmit the resource set information.

For example, before the step S11 or S11A, the TRP 20B may transmit information related to the CSI-RS resources of the TRP 20B to the TRP 20A using an X2 interface or via a core network.

As another example, the number of selectable CSI-RS resources may be configured with the UE 10 in advance. In such a case, the resource set information including the number of selectable CSI-RS resources may not be transmitted from the TRP 20 to the UE 10.

Tuning back to FIG. 3, at step S12, the TRP 20A transmits the CSI-RSs using resources #A1-#A4 to the UE 10. At step S13, the TRP 20B transmits the CSI-RSs using resources #B1-#B4 to the UE 10.

At step S14, the LTE 10 measures reception quality of the received CS-RSs in each of the CSI-RS resources. The reception quality may be Reference Signal Received Power (RSRP), RSRQ (Reference Signal Received Quality), and Received Signal Strength indicator (RSSI).

At step S15, the UE 10 select the CSI-RS resource(s) from the resources #A1-#A4 and #B1-#B4 based on the resource set information. The selection of the CSI-RS resources may be referred to as beam selection. For example, the UE 10 may select the CSI-RS resource(s) of which the number is indicated in the resource set information.

At step S16, the UE 10 performs the CSI reporting including CSI-RS resource indicator(s) (CRI(s)) associated with the selected CSI-RS resource(s) as CSI feedback. For example, the CSI may include a Rank Indicator (RI), a Precoding Matrix Indicator (PMI), a Channel Quality Indicator (CQI), and the RSRP in addition to the CRI.

For example, the CSI reporting may include only the CRI(s) associated with the selected CSI-RS resource(s). For example, the CRI(s) may include out-of-range (OoR) that indicates that the CSI-RS resources do not achieve metric, e.g., RSRP of all of the CSI-RS resources are less than a predetermined threshold value.

Example operations at the steps S15 and S16 will be explained below in detail.

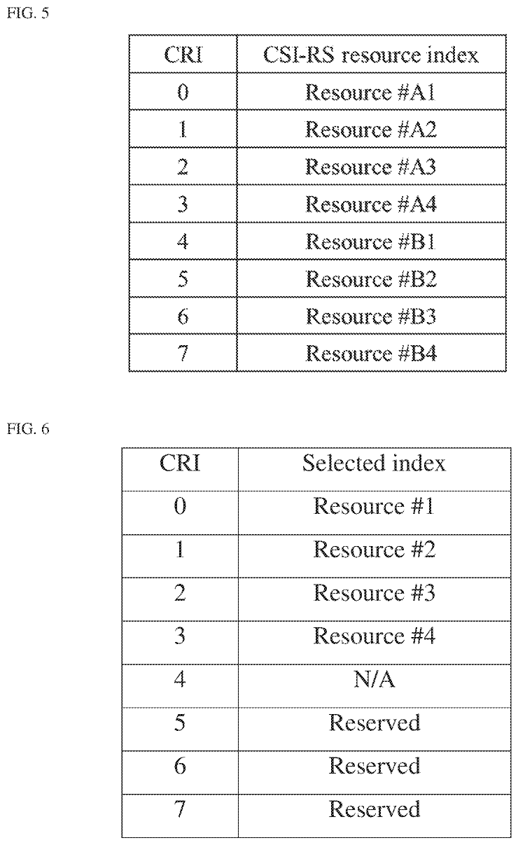

For example, the LT 10 includes a table of FIG. 5 where the CRIs are associated with the CSI-RS resources over the CSI-RS groups, that is, in the CSI-RS groups #A and #B. In an example of FIG. 5, CRIs #0-7 are associated with CSI-RS resources #A1-#A4 and #B1-#134, respectively. The UE 10 may select at least a CSI-RS resource and perform the CSI reporting including the CRI(s) corresponding to the selected CSI-RS resource's). For example, at the step S15, when the resource #A3 is selected, the CSI reporting includes the CRI “2.”

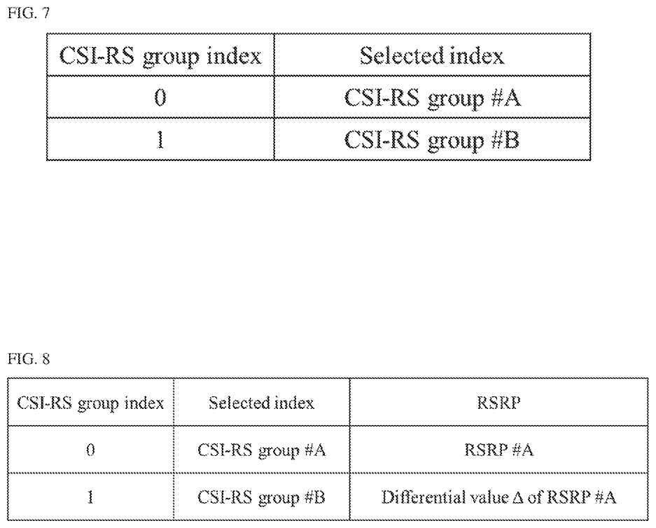

For example, the UE 10 includes a table of FIG. 6 where the CRIs are associated with the CSI-RS resources, “N/A,” and “Reserved.” In an example of FIG. 6, the CRIs 0-3 are associated with resources #1-#4, respectively. The resources #1-#4 indicate resources #A1-#A4, respectively, for beam management of TRP 20A. The resources #1-#4 indicate resources #B1-#B4, respectively, for beam management of TRP 20B. “N/A” indicates that there are no CSI-RS resources to be selected by the UE 10. “Reserved” indicates the reserved CRI. For example, when the LT 10 selects the resource #A2 and does not select the CSI-RSs from the resources #B1-#B4, the UE 10 may notify the TRP 20A of the CRI “1” indicating the resource #A2 and notify the TRP 20B of “NIA” as CSI feedback. As another example, when there are no CSI-RS resources to be selected from the resources #A1-#A4 and #B1-#B4, the UE 10 may notify the TRPs 20A and 20B of “N/A” as CSI feedback.

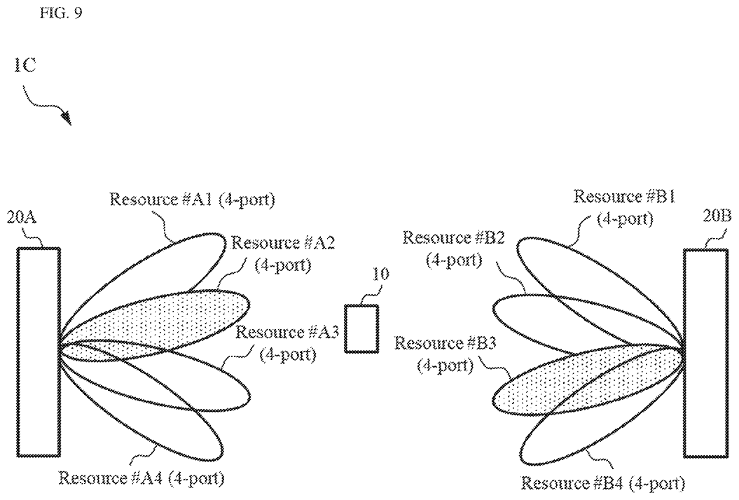

For example, as a group-based beam management scheme, the UE 10 includes a table of FIG. 7 where the CSI groups are associated with CSI-RS group indexes (GIs). In an example of FIG. 7, the CSI-RS groups #A and #B are associated with GIs 0 and 1, respectively. For example, when the CSI-RS group #B includes the CSI-RS resource having the best metric (e.g. reception quality such as RSRP) in the CSI-RS groups #A and #B, the UE 10 may notify the TRP 20B of the GI 1 as CSI feedback. As another example, an average value of metrics (e.g. RSRP) of CSI-RS resources selected by the UE 10 may be higher than that of the other CSI-RS group.

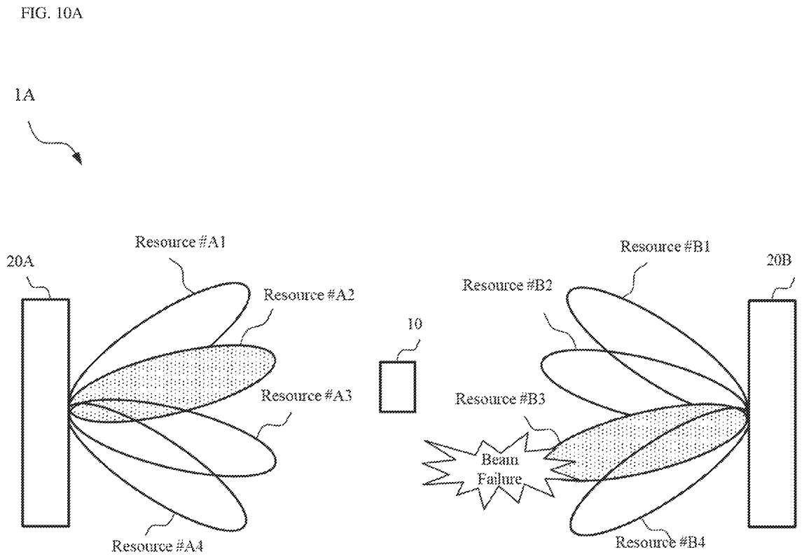

For example, in the group-based beam management scheme, differential feedback of the RSRP may be used for the CSI reporting. In the differential feedback of the RSRP, the RSRP of a CSI-RS group may be indicates as a differential value of the other CSI-RS group. As shown in FIG. 8, when the RSRP of the CSI-RS group #A is RSRP #A, the RSRP of the CSI-RS group #B may be indicated as a differential value Δ of the RSRP A. The CSI reporting may include the RSRP #A and the differential value Δ for the RSRP of the CSI-RS group #B. As another example, the UE 10 may include a reference RSRP value in each of the CSI-RS groups.

Turning back to FIG. 3, at the step S15, the CSI-RS resources may be selected based on the following methods in addition to the resource set information,

For example, at the step S15, the UE 10 may select the CSI-RS resources in descending or ascending order of a predetermined criteria such as the RSRP corresponding to the CSI-RS resources.

As another method of selecting the CSI-RS resources, the UE 10 may select at least a CSI-RS resource by assuming that the CSI-RS resource to be selected are spatial-multiplexed.

For example, the UE assumption including the above methods of selecting the CSI-RS resource may be switched.

According to embodiments of a modified example of the present invention, in beam management and CSI acquisition schemes, reception capability of the UE 10 (UE capability) may be considered. For example, at the steps S15 and S16 of FIG. 3, the number of the CSI-RS resources (CRIs) and ranks (RIs) selected as feedback information may be restricted so as to be less than or equal to the predetermined number based on the UE capability.

For example, the total number of the selected RIs over the CSI-RS groups may be less than or equal to the predetermined number such as the number of reception antennas of the UE 10. As an example, information on the restriction may be notified to the UE 10.

For example, the number of the selected CSI-RS resources may be less than or equal to the number of time and/or frequency tracking capability of the UE 10. For example, the maximum value of the number of time and/or frequency tracking capability is two, the number of different quasi co-location (QCL) states in the CSI-RS resources selected by the UE 10 may be less than or equal to two.

As another example, after the TRP 20 receives the UE capability from the LE 10, the TRP 20 may generate resource set information based on the UE capability. Then, for example, at the steps S11 of FIGS. 3 and S11A of FIG. 4, the TRP 20 may transmit the resource set information that designates the number of selectable CSI-RS resources that is less than or equal to the predetermined number the number of time and frequency tracking capability of the UE 10).

According to embodiments of another example of the present invention, beam management and CSI acquisition may be performed for multiple CSI-RS resources independently (first method). For example, in an example of FIG. 3, when the TRPs 20A and 20B transmit CSI-RSs using the resource #A1-#A4 and #B1-#B4, respectively, the beam management and CSI acquisition may be performed for each of parts of the CSI-RS resources (e.g., resources #A2 and #B3).

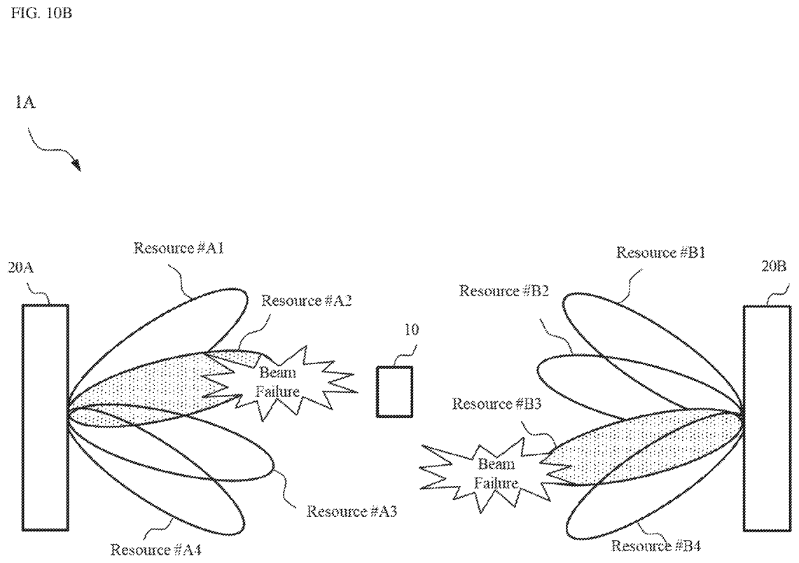

According to embodiments of another example of the present invention, beam management and CSI acquisition may be performed by assuming multiple CSI-RS resources as a single channel (second method). For example, in FIG. 9, the beam management and. CSI acquisition may be performed based on a joint channel (8-port) of resources #A2 and #B3. For example, the UE 10 may perform the beam management (e.g., CSI-RS resource selection) and the CSI acquisition (e.g., CSI reporting) based on one or more CSI-RS resources. For example, the LIE 10 may select a codebook based on the selected CSI-RS resources (or the number of CSI-RS resources)

For example, the above first and second methods included in the UE assumption may be switched.

In Rel. 15 NR, to correct a beam tracking error, a beam failure recovery (BFR) mechanism that supports only single-TRP/panel transmission is applied.

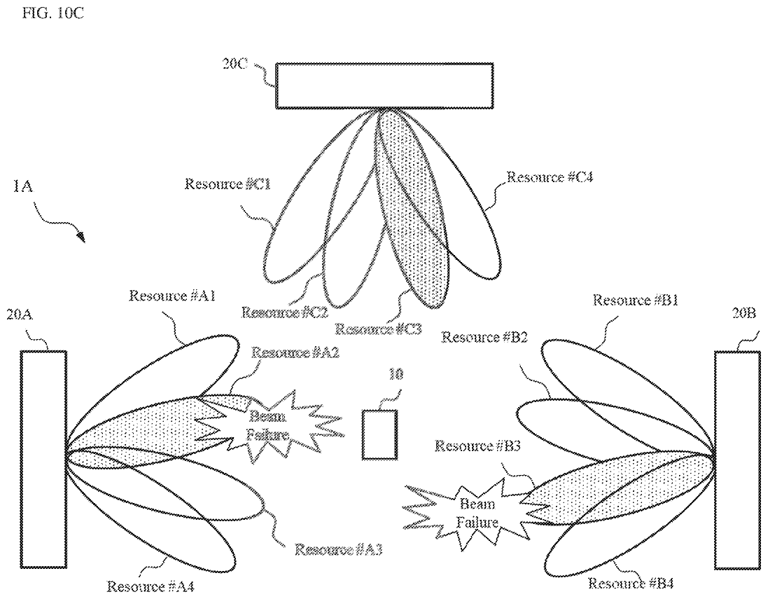

According to embodiments of the present invention, the BFR can be applied to multi-TRP/panel transmission. In FIGS. 10A and 9B, the UE 10 may communicate with the TRPs 20A and 20B using resources #A2 and #B3, respectively, as a result of the beam selection. In FIG. 10C, the UE 10 may communicate with the TRPs 20A, 20B, and 20C using resources #A2, #133, and #C3, respectively, as a result of the beam selection.

For example, as shown in FIG. 10A, when the UE 10 detects the beam failure in one of the multiple TRPs 20 (e.g., TRPs 20A and 20B), the UE 10 may determine that the beam failure occurs.

For example, as shown in FIG. 10B, when the FIG. 10 detects the beam failure in all of the multiple TRPs 20 (e.g., TRPs 20A and 20B), the UE 10 may determine that the beam failure occurs and transmit a recovery request to the TRPs 20A and 20B.

For example, as shown in FIG. 10C, the UE 10 may determine that the beam failure occurs, based on the number of beam failures or connections between the UE 10 and the TRP 20 in the CSI-RS groups. In an example of FIG. 10C, when the number of connections is less than or equal to two, the UE 10 may determine that the beam failure occurs.

When the UE 10 determine that the beam failure occurs, the LIE 10 may transmit the recovery request to the TRPs 20 using Physical Random Access Channel (PRACH) or Physical Uplink Control Channel (PUCCH).

The above method in embodiments of the present invention may be applied to other technologies in addition to the BFR in Rel. 15 NR.

(Configuration of TRP)

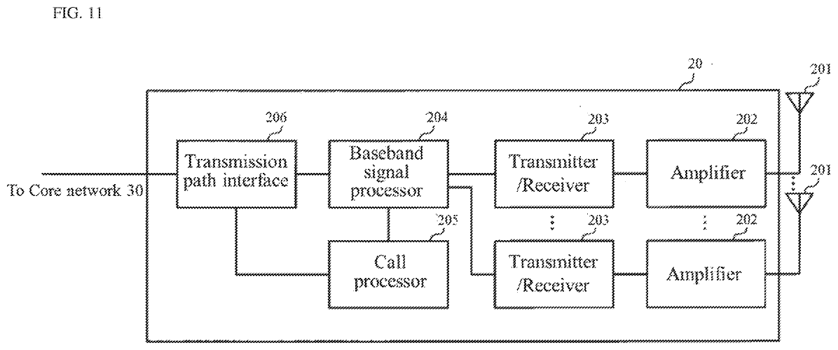

The TRP 20 according to embodiments of the present invention will be described below with reference to FIG. 11. FIG. 11 is a diagram illustrating a schematic configuration of the TRP 20 according to embodiments of the present invention. The TRP 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the TRP 20 to the UE 20 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and preceding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the TRP 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PI)CP layer reception processing on the user data included in the received baseband signals. Then, the resultant signals are transferred to the core network through the transmission path interface 206. The call processor 205 performs call processing such as setting up and releasing a communication channel, manages the state of the TRP 20, and manages the radio resources.

(Configuration of UE)

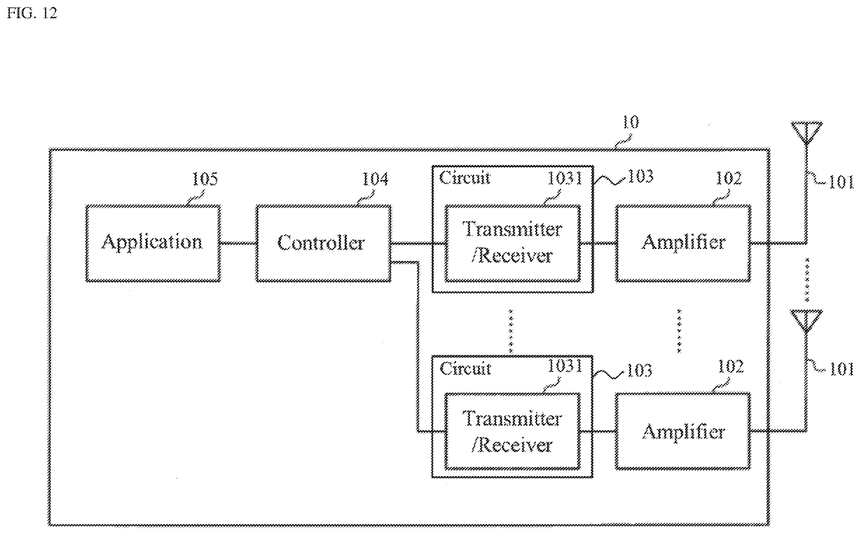

The UE 10 according to embodiments of the present invention will be described below with reference to FIG. 12. FIG. 12 is a schematic configuration of the UE 10 according to embodiments of the present invention. The UE 10 has a plurality of HE antenna S101, amplifiers 102, the circuit 103 comprising transceiver transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

(Another Example)

Although the present disclosure mainly described examples of multi-TRP transmission, the present invention is not limited thereto. Embodiments of the present invention may apply to multi-panel transmission. That is, in embodiments of the present invention, multiple panels may be co-located or non-co-located.

Embodiments of the present invention may be used for each of the uplink and the downlink independently. Embodiments of the present invention may be also used for both of the uplink and the downlink in common. The uplink channel and signal may be replaced with the downlink signal channel and signal. The uplink feedback information (e.g., CSI) may be replaced with the downlink control signal.

Although the present disclosure mainly described examples of a channel and signaling scheme based on NR, the present invention is not limited thereto. Embodiments of the present invention may apply to another channel and signaling scheme having the same functions as NR such as LTE/LTE-A and a newly defined channel and signaling scheme.

Although the present disclosure mainly described examples of technologies related to beam management, beam recovery (e.g., BFR), channel estimation, and CSI feedback (e.g., CSI reporting) schemes based on the CSI-RS, the present invention is not limited thereto. Embodiments of the present invention may apply to another synchronization signal, reference signal, and physical channel such as Primary Synchronization Signal/Secondary Synchronization Signal (PSS/SSS) and Demodulation Reference Signal (DM-RS).

Although the present disclosure described examples of various signaling methods, the signaling according to embodiments of the present invention may be explicitly or implicitly performed.

Although the present disclosure mainly described examples of various signaling methods, the signaling according to embodiments of the present invention may be higher layer signaling such as RRC signaling and/or lower layer signaling such as Down Link Control Information (DCI) and Media Access Control Control Element (MAC CE). Furthermore, the signaling according to embodiments of the present invention may use a Master Information Block (MIB) and/or a System Information Block (SIB). For example, at least two of the RRC, the DCI, and the MAC CE may be used in combination as the signaling according to embodiments of the present invention.

According to embodiments of the present invention, whether the physical signal/channel is beamformed may be transparent for the UE. The beamformed RS and the beamformed signal may be called the RS and the signal, respectively. Furthermore, the beamformed RS may be referred to as a RS resource. Furthermore, the beam selection may be referred to as resource selection. Furthermore, the Beam Index may be referred to as a resource index (e.g., CRI) or an antenna port index.

Embodiments of the present invention may be applied to CSI acquisition, channel sounding, beam management, and other beam control schemes.

In embodiments of the present invention, the frequency (frequency-domain) resource, a Resource Block (RB), and a subcarrier in the present disclosure may be replaced with each other. The time (time-domain) resource, a subframe, a symbol, and a slot may be replaced with each other,

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A user equipment (LIE) comprising:
a receiver that receives:
resource set information that indicates the number of selectable Channel State Information Reference Signal (CSI-RS) resources between a first CSI-RS group and a second CSI-RS group;
CSI-RSs using first CSI-RS resources in the first CSI-RS group; and
CSI-RSs using second CSI-RS resources in the second CSI-RS group;
a processor that selects at least a CSI-RS resource from the first CSI-RS resources and the second CSI-RS resources based on the resource set information; and
a transmitter that performs CSI reporting that indicates the selected CSI-RS resource.

2. The UE according to claim 1, wherein the number of the selected CSI-RS resources is the number of selectable CSI-RS resources in the resource set information.

3. The UE according to claim 1, wherein the number of the selected CSI-RS resources is less than or equal to the number of selectable CSI-RS resources in the resource set information.

4. The UE according to claim 1, wherein the number of the selected. CSI-RS resources is less than or equal to the number of a maximum value of time-frequency tracking capability of the UE.

5. The UE according to claim 1, wherein the number of the selectable CSI-RS resources is designated in each of the first CSI-RS group and the second CSI-RS group.

6. The UE according to claim 1, wherein the CSI-RSs using the first CSI-RS resources and the CSI-RSs using the second CSI-RS resources are transmitted from different transmission and reception points (TRPs), respectively.

7. The UE according to claim 1, wherein the CSI-RSs using the first CSI-RS resources and the CSI-RSs using the second CSI-RS resources are transmitted from different panels in a TRP, respectively.

8. A wireless communication method comprising:
transmitting, from a base station (BS) to a user equipment (UE):
resource set information that indicates the number of selectable Channel State Information Reference Signal (CSI-RS) resources between a first CSI-RS group and a second CSI-RS group;
CSI-RSs using first CSI-RS resources in the first CSI-RS group; and
CSI-RSs using second CSI-RS resources in the second CSI-RS group;
selecting, with the UE, at least a CSI-RS resource from the first CSI-RS resources and the second CSI-RS resources based on the resource set information; and
performing, with the UE, CSI reporting that indicates the selected CSI-RS resource.

9. The wireless communication method according to claim 8, wherein the number of the selected CSI-RS resources is the number of selectable CSI-RS resources in the resource set information.

10. The wireless communication method according to claim 8, wherein the number of the selected CSI-RS resources is less than or equal to the number of selectable CSI-RS resources in the resource set information.

11. The wireless communication method according to claim 8, wherein the number of the selected CSI-RS resources is less than or equal to the number of a maximum value of time-frequency tracking capability of the UE.

12. The wireless communication method according to claim 8, wherein the number of the selectable CSI-RS resources is designated in each of the first CSI-RS group and the second CSI-RS group.

13. The wireless communication method according to claim 8, wherein the CSI-RSs using the first CSI-RS resources and the CSI-RSs using the second CSI-RS resources are transmitted from different transmission and reception points (TRPs), respectively.

14. The wireless communication method according to claim 8, wherein the CSI-RSs using the first CSI-RS resources and the CSI-RSs using the second CSI-RS resources are transmitted from different panels in a TRP, respectively.
